(19) United States
(12) Patent Application Publication
(10) Pub. No.: US 2011/0040631 A1
(43) Pub. Date: Feb. 17, 2011

(54) Personalized commerce system

(76) Inventor: Jeffrey Scott Eder, Mill Creek, WA (US)

Correspondence Address: ASSET TRUST, INC., 2020 MALTBY ROAD, SUITE 7362, BOTHELL, WA, 98021, US

(21) Appl. No.: 12/910,829

(22) Filed: Oct. 24, 2010

Related U.S. Application Data
(63) Continuation-in-part of application No. 11/358,196, filed on Feb. 21, 2006.
(60) Provisional application No. 60/697,441, filed on Jul. 9, 2005.

(51) Int. Cl. G06Q 30/00

(52) U.S. Cl. 705/14.67

(57) ABSTRACT

An automated method, media and system for advertising, configuring, offering, producing, and/or delivering offerings that are appropriate to the context of a specific individual, group or organization.

### CONTINUATION IN PART AND CROSS REFERENCE TO RELATED APPLICATIONS, PATENTS AND PROVISIONAL APPLICATIONS

This application is a continuation in part of application Ser. No. 11/358,196 filed Feb. 21, 2006 the disclosure of which is incorporated herein by reference in its entirety. application Ser. No. 11/358,196 is a non provisional of provisional application 60/1697,441 filed Jul. 7, 2005 which is incorporated herein by reference. The subject matter of this application is related to the subject matter of U.S. patent application Ser. No. 11/094,171 filed Mar. 31, 2005 which matured into U.S. Pat. No. 7,730,063 the disclosure of which is incorporated herein by reference. Application Ser. No. 11/094,171 is a continuation in part of U.S. patent application Ser. No. 10/717,026 filed Nov. 19, 2003 which matured into U.S. Pat. No. 7,401,057 and is a non provisional application of U.S. Provisional Patent Application No. 60/566,614 filed on Apr. 29, 2004 the disclosures of which are all also incorporated herein by reference. application Ser. No. 10/717,026 claimed priority from U.S. Provisional Patent Application No. 60/432,283 filed on Dec. 10, 2002 and U.S. Provisional Patent Application No. 60/464,837 filed on Apr. 23, 2003 the disclosures of which are also incorporated herein by reference. The subject matter of this application is also related to the subject matter of U.S. patent application Ser. No. 10/237,021 filed Sep. 9, 2002, U.S. patent application Ser. No. 10/242,154 filed Sep. 12, 2002, U.S. patent application Ser. No. 10/071,164 filed Feb. 7, 2002, U.S. patent application Ser. No. 10/746,673 filed Dec. 24, 2003, U.S. patent application Ser. No. 11/167,685 filed Jun. 27, 2005, U.S. patent application Ser. No. 11/262,146 filed Oct. 28, 2005, U.S. patent application Ser. No. 11/268,081 filed Nov. 7, 2005 and U.S. patent application Ser. No. 12/114,784 filed May 4, 2008 the disclosures of which are all incorporated herein by reference. The subject matter of this application is also related to the subject matter of U.S. Pat. No. 7,039,654 for “Automated Bot Development System”, by Jeff S. Eder, the disclosure of which is incorporated herein by reference.

### BACKGROUND OF THE INVENTION

This invention relates to a method of and system for advertising, configuring, producing, offering and/or delivering information (aka media), products and/or services (hereinafter offerings) that are appropriate to the context of a specific individual, group or organization and optimal for the entity providing the advertising or offering. The five steps, advertising, configuring, producing, offering, and delivering, comprise five steps or stages in a commerce chain. The system incorporates a program storage device to guide the completion of the required processing by the processors in the computer system. The offerings may be sold “as is” and/or they may be personalized (also referred to as customized) to match a specific context of the individual, group or organization.

### SUMMARY OF THE INVENTION

It is a general object of the invention described herein to provide a novel and useful system for advertising, configuring, producing, offering and delivering information, media, products and/or services that are appropriate to the context of a specific individual, group or organization (hereinafter, entity). The offerings may be optimal for the user and/or for the offering entity. Join optimization may be completed by defining a system (as detailed in cross referenced patent Ser. No. 11/094,171) and optimizing the system. The information, media, products and/or services may be sold “as is” and/or they may be customized (aka personalized) to match a specific context of an entity.

The data regarding the context of an entity are continuously analyzed and updated using the entity centric computer system (30) described in cross referenced U.S. patent application Ser. No. 10/717,026. The entity centric computer system (30), in turn communicates with a number of other systems (please see FIG. 1) as required to support the entity and complete one or more of the five steps in a commerce chain.

By eliminating many of the gaps in information available to personnel in each stage (or step) of the commerce chain, the system described herein enables the just-in-time development and delivery of offerings that are tailored to the exact needs of the entity receiving the offering and the entity providing the offering. The electronic linkages also provide the potential to eliminate the waste that comes from developing and shipping products that don't match current needs.

### BRIEF DESCRIPTION OF DRAWINGS

These and other objects, features and advantages of the present invention will be more readily apparent from the following description of the one embodiment of the invention in which:

FIG. 1 is a block diagram showing the major systems in the personalized commerce system;

FIG. 2 is a diagram showing the five primary steps in a personalized commerce system;

FIG. 3 is a block diagram of an implementation of the Personalized Commerce System (100) described herein;

FIG. 4 is a diagram showing the data windows that are used for receiving information from and transmitting information to a system operator (21) and/or a customer (22) during system processing;

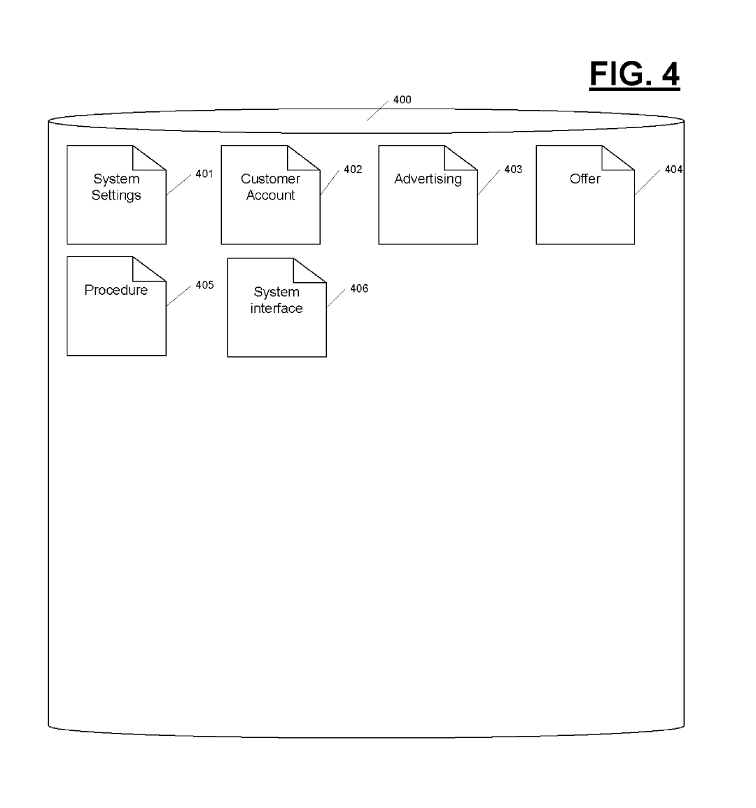

FIG. 5 is a diagram showing the tables in the application database (51) described herein that are utilized for data storage and retrieval during the processing in the innovative Personalized Commerce System (100); and

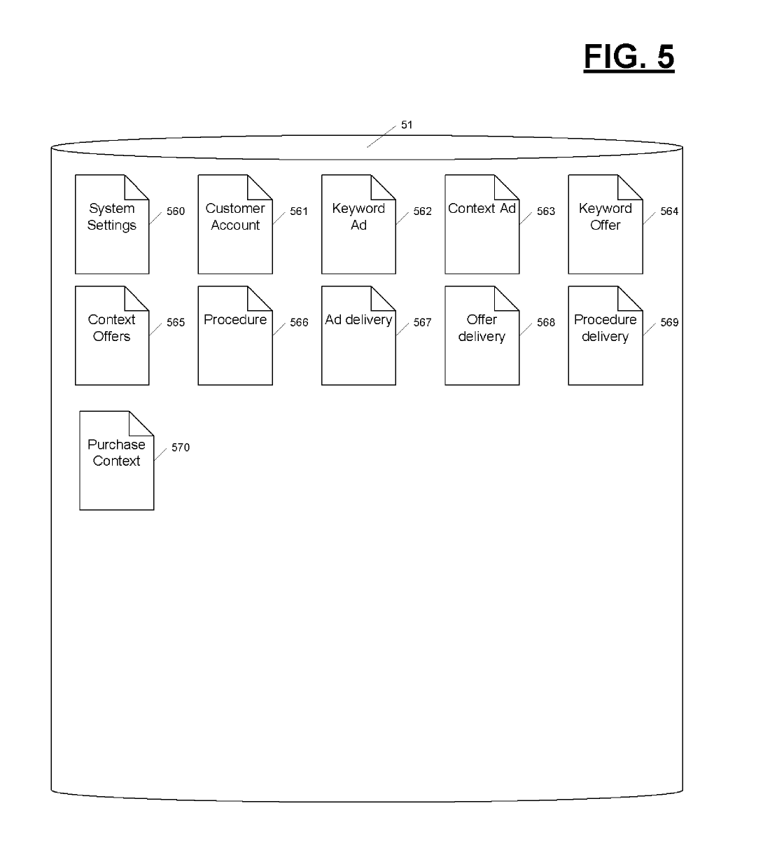

FIG. 6 is a block diagram showing the sequence of steps in the present invention used for specifying system settings and operating the Personalized Commerce System (100).

### DETAILED DESCRIPTION OF ONE EMBODIMENT

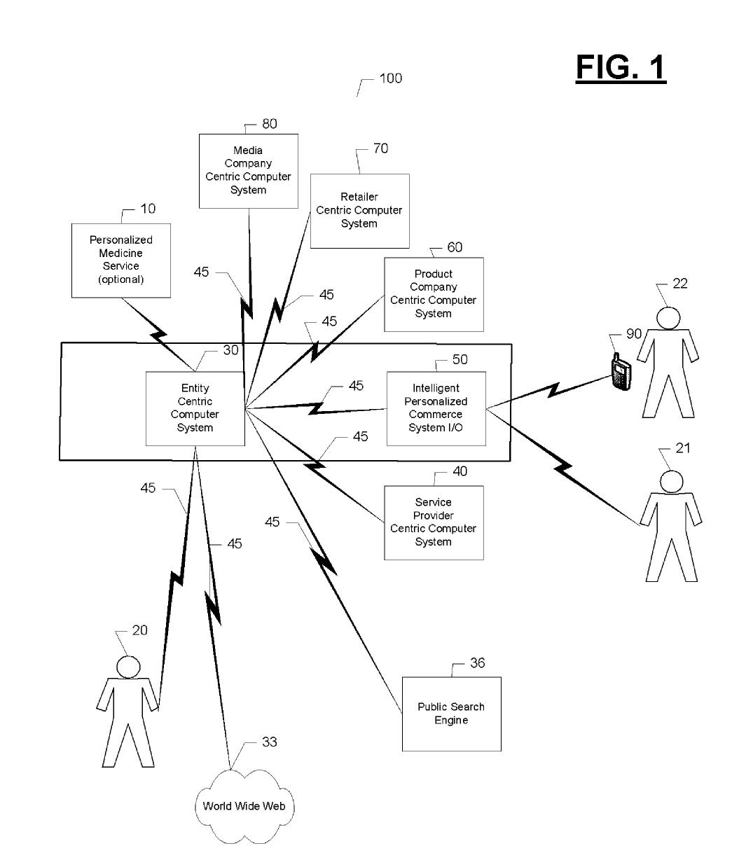

FIG. 1 provides an overview of the systems that are used to define and operate a personalized commerce system. The personalized commerce system is used for advertising, configuring, producing, offering and/or delivering information, media, products and/or services (hereinafter, collectively and/of individually as offerings) that are appropriate to the context of a specific user entity.

In accordance with the present invention, the starting point for processing is an entity centric computer system (30) that identifies the current context for an entity using as many as seven of the primary layers (or aspects) of context as well as other aspects of context that are appropriate as described in cross referenced U.S. patent application Ser. No. 10/717,026. As shown in FIG. 1, the context of any entity may also be influenced by information from a personalized medicine service (10) that is described in cross referenced U.S. patent application Ser. No. 11/094,171 or another service providing similar information.

An individual's health can have a wide variety of effects on the context of an individual. For example, a chronic illness can dictate virtually every action that an individual needs to take during every minute of every day. On the other extreme, a cold or virus may have a minor impact on an individual's behavior for a day or two. Because the impact is generally limited to specific elements of context and or resources over a specific time period, the entity centric computer system (30) treats the input from the personalized medicine service (10) regarding a disease or illness in the manner described in cross referenced U.S. patent application Ser. No. 11/094,171 for a project. Like a project, each illness would be expected to have an impact on one or more specific elements and/or resources for a specified period of time. In some cases, the change in elements and/or resources may be permanent—also like a project. The actual impact and amount of time will of course vary and the personalized medicine service (10) provides the entity centric computer system (30) with the input required to adjust the current and forecast context for an entity in response to the actual evolution of an illness or condition. Information regarding disease impact on an different aspects of an entity context may also be obtained from other sources such as the open source models of diseases developed by Sage BioNetworks. As noted in FIG. 1, the use of a personalized medicine service (10) to influence the context of an entity is optional.

Before going on to discuss the interaction of the entity centric computer system (30) with the other functionality that comprise the personalized commerce system, it should be noted that the present invention incorporates five improvements to the personalized medicine service (10) described in U.S. patent application Ser. No. 11/094,171 and the entity centric computer system described in cross referenced U.S. patent application Ser. No. 10/717,026.

The first improvement is that the timing of the delivery of Complete Context™ Scout (616) reports, the Complete Context™ Journal (630) and/or the Complete Context™ Review (607) reports described therein are influenced by a predictive model that identifies the time(s) when the entity (or the entity representative) is most likely to be unreceptive to receiving an interruption. More specifically, the receptiveness to interruption is evaluated in an automated fashion by a predictive model in the Complete Context™ Metrics and Rules System (611) that processes input from sensors to produce an interruptibility score—the higher the score the less likely the user (20) is likely to want an interruption. It is now well established that a number of activities are associated with the desire of an individual to work without interruption and that these activities can be reliably and unobtrusively detected by sensors. While the desire to proceed without interruption is generally respected, the entity centric computer system (30) balances this desire against the criticality of the information that is contained in a Complete Context™ Review (607) report, Complete Context™ Scout (616) report and/or Complete Context™ Journal (630) to ensure optimal support under all circumstances. Criticality is determined on the basis of likely change in behavior using the Complete Context™ Scout (616) analysis. The Complete Context™ Metrics and Rules System (611) will adjust the over-ride level as part of the normal learning process detailed in the cross referenced applications.

The second improvement to the personalized medicine service (10) and the entity centric computer system (30) involves the use of spectral risk measures to adjust the “objective” analysis of risk completed by these entity centric computer system (30) or personalized medicine service (10) for the behavior of the entity (or the entity representative). It is well established that an individual's perception of the severity of a risk is in many cases not in agreement with the actual “objective” measure of said risk. The use of spectral risk measures provides the ability to adjust the entity context to the perceived level or risk as opposed to the objective measure of risk.

The third improvement to the personalized medicine service (10) and the entity centric computer system (30) involves improvements to the associated Complete Context™ Scout (616) and Complete Context™ Search (609) services. More specifically, the improvements comprise the addition of the option to use similarity measures such as simfusion, weighted simfusion (simfusion algorithm with results weighted for relative impacts identified by the entity centric computer system (30)), trusted simfusion (weighted simfusion algorithm results weighted for reliability of source), simrank, weighted simrank (simrank algorithm with results weighted for relative impacts identified by the entity centric computer system (30)), trusted simrank (weighted simrank algorithm weighted for reliability of source) algorithms and combinations thereof to the algorithms used by these applications (10 and 30) to identify relevant data, information and/or knowledge for an entity context. These algorithms can also be used to identify context matches.

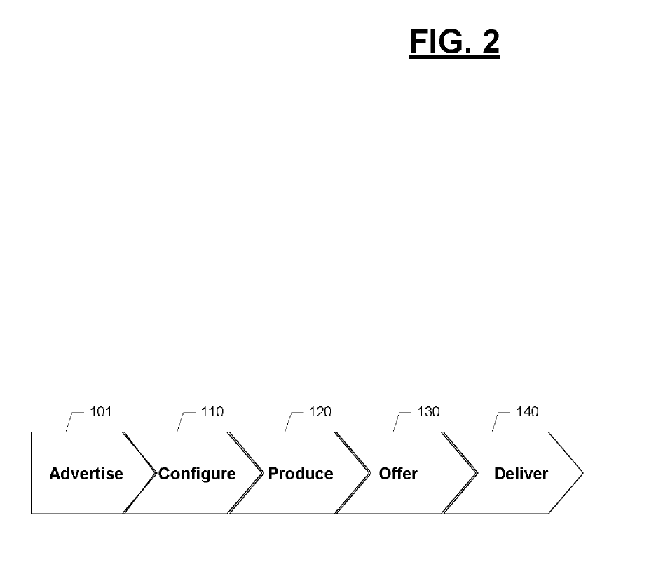

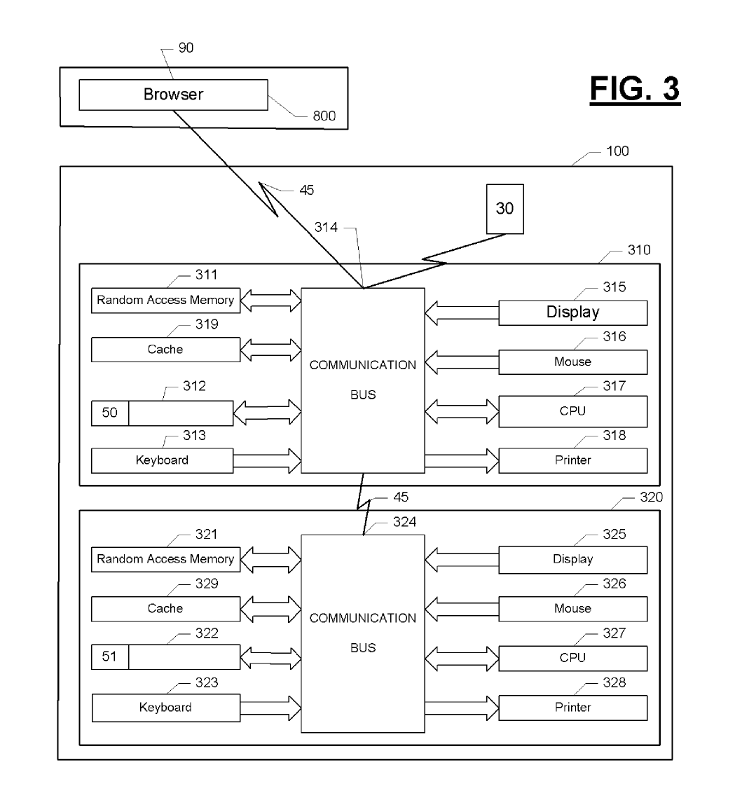

The fourth improvement to the personalized medicine service (10) and the entity centric computer system (30) involves the automated identification of a general lexicon layer for an entity. The lexicon layer identification is completed in 3 distinct stages. First, the 10,000 most common words or symbols for the primary language of the user (20) are added to these systems as a baseline lexicon layer during system initialization. These baseline listings are developed in an automated fashion from one or more of the readily available corpora for the most common languages (i.e. English, Spanish, German, Egyptian Arabic, Mandarin Chinese, French, Japanese, Farsi, Hindi, Korean, Turkish, Vietnamese, etc.) using term recognition algorithms such as C-Value, TD-IDF and Term exctractor alone or in combination with one another and vocabulary extraction algorithms such as binary consensus, logged term frequency and normalized term frequency alone or in combination with one another. The words or symbols contained in the entity's data are then analyzed and compared to the baseline listings to identify words that need to be added to the lexicon layer, words that are used with a significantly higher frequency than normal and to identify word associations. Finally, the words in the user's lexicon that are associated with the other layers of context are mapped (or added) to the lexicon layer as required to fully integrate semantic data to the context models (i.e. see FIG. 2A, FIG. 2B or FIG. 3 in cross referenced U.S. patent application Ser. No. 10/717,026).

The fifth improvement is that the personalized medicine service (10) and the entity centric computer system (30) communicate regularly with the Personalized Commerce System (100) during its operation. The benefits of enabling this communication will be detailed below.

As shown in FIG. 1, the entity centric computer system (30) links via a network connection (45) with an entity centric computer system for a service provider (40), a product company (60), a retailer (70) and/or a media company (80) such as a digital advertising agency. The product company, retailer, service provider and media company will be referred to as offering entities. While only one instance of each type of company is shown it is to be understood that the entity centric computer system (30) can interface and interact with a plurality of each type of company and/or other types of companies that are using an entity centric computer system or a system capable of providing the same information. Because the systems (40, 60, 70 and 80) for these companies are identical to the entity centric computer system (30)—save for the fact that the entity being supported is different—the previously identified improvements are also incorporated in their functionality and operation. As shown in FIG. 1, the entity centric computer system (30) also links via a network connection (45) with a world wide web (33) and a public search engine (36) such as Google, Technorati, Yahoo, MSN, Ask, Exalead, Looksmart, Beyond.com and/or AltaVista. While only one public search engine is shown it is to be understood that the system can interface and interact with a plurality of public search engines (36) including vertical search engines as well as non-public search engines such as those used for enterprise search.

The final piece in the personalized commerce system is the Personalized Commerce Input Output System (50). The operation of the Personalized Commerce System (100) will be detailed below as part of the description of how the Personalized Commerce System (100) enables and supports the completion of each of the five steps of the personalized commerce chain shown in FIG. 2. In one embodiment, the Personalized Commerce System (100) is comprised of two computers (310, 320), the Personalized Commerce Input Output System (50), an application database database (51) and an entity centric computer system (30) as described in cross referenced U.S. patent application Ser. No. 10/717,026. As shown in FIG. 3, one embodiment of two computers is a user-interface personal computer (310) connected to a database-server computer (320) via a network (45). The user interface personal computer (310) is also connected via the network (45) to an internet access device (90) such as a computer or a smartphone that contains browser software (800) such as Opera or Mozilla Firefox. While only one instance of an entity centric computer system for a user is shown, it is to be understood that the system may interface with entity centric computer systems for more than one user.

The user-interface personal computer (310) has a read/write random access memory (311), a hard drive (312) for storage of a customer data table and the Personalized Commerce Input Output System (50), a keyboard (313), a communications bus containing all adapters and bridges (314), a display (315), a mouse (316), a CPU (317) and a printer (318).

The database-server personal computer (320) has a read/write random access memory (321), a hard drive (322) for storage of the application database (51), a keyboard (323), a communications bus card containing all adapters and bridges (324), a display (325), a mouse (326) and a CPU (327).

Again, it is to be understood that the diagram of FIG. 3 is merely illustrative of one embodiment described herein as the entity centric computer system (30) and Personalized Commerce Input Output System (50) could reside on a single computer or any number of computers that are linked together using a network or grid. In a similar manner a system operator (21) and/or a customer (22) could interface directly with one or more of the computers in the system (100) instead of using an internet access device (90) with a browser (800) as described in the one embodiment. Along these same lines, the service provider (40), product company (60), retailer (70) and/or a media provider (80) computer systems could also be hosted on the same computer system

A personalized commerce input output system software (200) controls the performance of the central processing unit (317) as it completes the calculations used to support the advertising, configuring, offering, selling and/or delivery of offerings (information, media, products and/or services) that are appropriate to the context of a specific entity. In the embodiment illustrated herein, the software program (200) is written in a combination of C# and Java although other languages can be used to the same effect. The customer (22) and system operator (21) can optionally interact with the application software (200) using the browser software (800) in the internet access device (90) to provide information to the application software (200) for use in completing one or more of the steps in the personalized commerce chain.

The computers (310 and 320) shown in FIG. 3 illustratively are personal computers or any of the more powerful computers (such as workstations or mainframe computers) that are widely available. Typical memory configurations for client personal computers (310) used with the present invention should include at least 2056 megabytes of semiconductor random access memory (311) and at least a 160 gigabyte hard drive (312). Typical memory configurations for the database-server computer (320) used with the present invention should include at least 5128 megabytes of semiconductor random access memory (321) and at least a 5 terabyte hard drive (322).

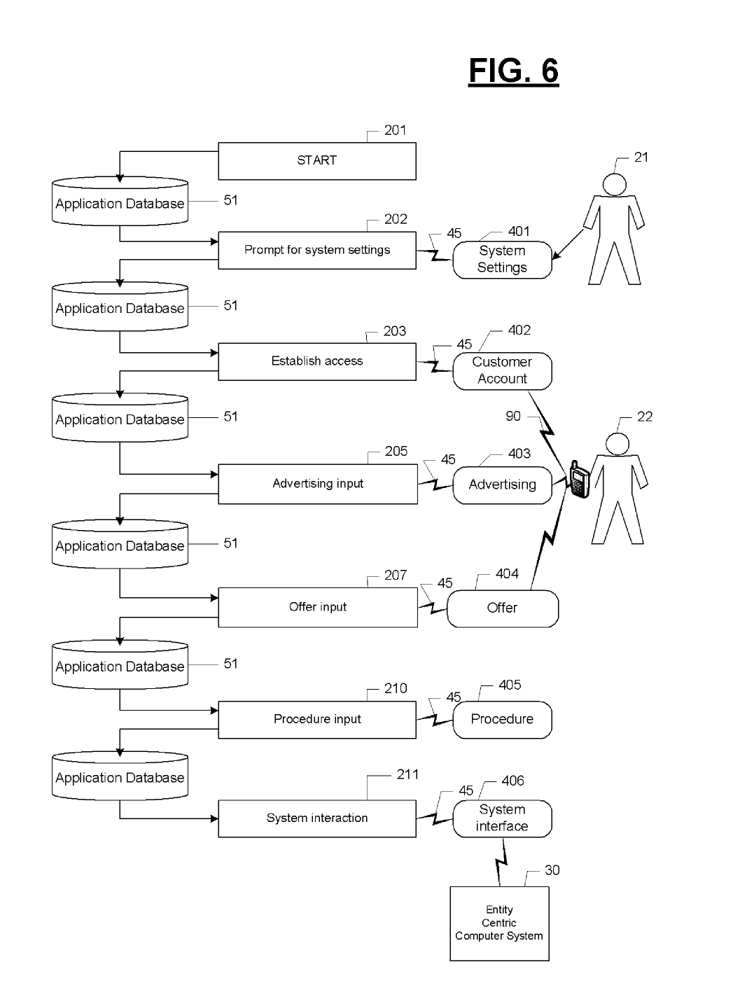

Using the systems described above, entity data are combined with data from a media company (80), a retailer (70), a service provider (40), a product company (60), the world wide web (33) and/or a public search engine (36) in the Personalized Commerce System (100) and analyzed before the data and information required to complete a step of the personalized commerce chain is developed and/or transmitted by the entity centric computer system (30). As detailed below, the data and information required to complete all or part of some steps can in some cases be completed without the Personalized Commerce System (100). FIG. 6 details the processing that supports the completion of one or more of the steps in processing.

### System Operation

The flow diagrams in FIG. 6 details the processing by the Personalized™ Commerce System (100) required to obtain the information that supports the completion of the each of the steps in the personalized commerce chain.

The personalized medicine service (10) described in U.S. patent application Ser. No. 11/094,171 and the entity centric computer system (30) described in cross referenced U.S. patent application Ser. No. 10/717,026 each contain a number of features, services and/or systems (hereinafter, services) that support one or more of the five steps in the personalized commerce chain. The table below shows some of the specific services that support each step.

TABLE 1

| Commerce Chain | | |
|---|---|---|
| Step | Support | Detailed description |
| Advertise (101) | Complete Context ™ | Identifies data, information and/or |
| | Search (609) alone or | knowledge relevant to entity context - |
| | with other services | can be used to dramatically improve |
| | | keyword linked ads and/or enable |
| | | context linked ads/offers |
| Advertise (101) | Complete Context ™ | Identifies data, information and/or |
| | Scout (616) alone or with | knowledge relevant to pending entity |
| | other services | decisions - can be used to dramatically |
| | | improve keyword linked ads and/or |
| | | enable context linked ads/offers |
| Advertise (101) | Complete Context ™ | Identifies newly developed data, |
| | Journal (630) alone or | information and/or knowledge relevant |
| | with other services | to entity context - can be used to |
| | | dramatically improve keyword linked |
| | | ads and/or enable context linked |
| | | ads/offers |
| Advertise (101) | Complete Context ™ | Identifies one or more sets of features |
| | Customization Service | that should be included in or expressed |
| | (621) alone or with other | by an ad for an entity for a given |
| | services such as the | context |
| | Optimization Service | |
| Configure (110) | Complete Context ™ | A summary of entity context using that |
| | Summary Service (617) | can be used to develop a configuration |
| | alone or with other | for a user entity |
| | services | |
| Configure (110) | Complete Context ™ | Identifies one or more sets of features |
| | Customization Service | that should be included in or expressed |
| | (621) alone or with other | by an offering for an entity for a given |
| | services such as the | context frame or sub-context frame. |
| | Optimization Service | |
| Configure (110) | Complete Context ™ | Guides one or more collaborators |
| | Capture and | through a series of steps in order to |
| | Collaboration Service | capture information, refine existing |
| | (622) alone or with other | knowledge and/or develop plans for the |
| | services | future. |
| Produce (120) | Complete Context ™ | Identifies and develops securities and |
| | Underwriting Service | transactions that support entity |
| | (620) alone or with other | performance |
| | services | |
| Produce (120) | Complete Context ™ | Service for establishing measure |
| | Planning Service (605) | priorities, establish action priorities, |
| | alone or with other | and expected performance levels for |
| | services | actions, events, elements resources |
| | | and measures. |
| Produce (120) | Complete Context ™ | Analyzes and optimizes the impact of a |
| | Project Service (606) | project or a group of projects on a |
| | alone or with other | context frame (note: project is broadly |
| | services | defined to include any development or |
| | | diminution of any components of |
| | | context). |
| Offer (130) | Complete Context ™ | A summary of entity context that can |
| | Summary Service (617) | be used to develop an offer. |
| | alone or with other | |
| | services | |
| Offer (130) | Complete Context ™ | Identifies an optimal* price for an offer |
| | Optimization Service | to an entity for a given context frame or |
| | (604) alone or with other | sub-context frame. |
| | services | |
| Offer (130) | Complete Context ™ | Identifies desirable exchanges of |
| | Exchange Service (608) | resources, elements, commitments, |
| | alone or with other | data and information with other entities |
| | services | in an automated fashion |
| Offer (130) | Complete Context ™ | Obttains information required to |
| | Input Service (601) alone | completes sales transactions |
| | or with other services | |
| Deliver (140) | Complete Context ™ | Service for establishing measure |
| | Planning Service (605) | priorities, establish action priorities, |
| | alone or with other | and expected performance levels for |
| | services | actions, events, elements resources |
| | | and measures. |
| Deliver (140) | Complete Context ™ | Service for reviewing components of |
| | Review Service (607) | context and entity measures alone or in |
| | alone or with other | combination. |
| | services | |
| Deliver (140) | Complete Context ™ | Service for forecasting the value of |
| | Forecast Service (603) | specified variable(s) using data from all |
| | alone or with other | relevant context layers with a |
| | services | multivalent combination of forecasts |
| | | from a tournament of different |
| | | approaches |

*optimal offer can be determined for a single entity or a plurality of entities

Before going further it is important to note that the ability to complete processing using these services depends on the user (20) giving permission to expose the required information via the Complete Context™ Display Service (614). Bots can also be used to complete one or more of the steps in the personalized commerce system processing as detailed in cross referenced U.S. patent application Ser. No. 10/242,154 and in one or more of the other cross referenced applications.

Most of the key terms have already been defined in one or more cross referenced applications. However, the terms used to describe the, personalized commerce system have not been defined so we will define them in below before detailing the operation of the Personalized Commerce System (100). The definitions are as follows:
1. Ad—a paper or electronic document that provides information about an offering,
2. Advertise—to announce or provide information about an offering in a ad in order to induce an entity to buy, lease, rent and/or use said offering;
3. Article—an instance of media included in a Complete Context™ journal for an entity;
4. Configure—to put together or arrange the parts of an offering in a specific way or for a specific purpose;
5. Keyword—a word or combination of words that will trigger the delivery of one or more advertisements, offers and/or processes to a user when it appears in an article, a search and/or a predictive search (aka Complete Context™ Scout);
6. Media—data or information from any source other than the entity—i.e. articles from newspapers, video from TV. programs, recordings from radio programs, podcasts from radio and/or TV. programs, blog entries, pages from web sites, music from i-tunes; etc.
7. Offer—provide specific terms and conditions for completing a sale;
8. Production—to cause the existence of an offering;
9. Deliver—to cause transfer of an offering to a user;
10. Sell—to transfer an offering in exchange for consideration;
11. Service—a set of one or more activities;
12. Context—as in cross referenced patent application Ser. No. 10/717,026, a context identifies and defines an impact of up to eight context layers, element, resource, environment, transaction, reference, measure, relationship and lexical, on (user) entity function measures. As noted previously, a context also optionally includes input from a personalized medicine service,
13. Offering,—something of value made available to a user, they are different at each stage of the commerce chain as shown below in Table 2.

TABLE 2

| Commerce | |
|---|---|
| Chain Stage | Offerings |
| Advertise | ad |
| Configure | Product configuration, service configuration, information |
| | configuration, etc. |
| Produce | data, information, knowledge, media, product(s), service(s) |
| Offer | Terms (price, date available, bundle, discount etc.) and |
| | Conditions (time or sale, 30 days, 90 days, etc.) |
| Deliver | Mode of delivery (electronic, physical), delivery location |
| | (smartphone, in-store), delivery timing (instant, overnite, |
| | etc.), |

With these definitions in place we will now detail the operation of the innovative Personalized Commerce System (100). System processing starts in a block 601, FIG. 6A, which immediately passes processing to a software block 602. The software in block 202 prompts the system operator (21) via a system settings data window (401) to provide a plurality of system setting information. The system setting information is stored in a system settings table (560) in the application database (51) in a manner that is well known. The specific inputs the system operator (21) is asked to provide at this point in processing are shown in Table 3.

TABLE 3

| | |
|---|---|
| 1. | Metadata standard (XML or RDF) |
| 2. | Base currency for all pricing |
| 3. | Default missing data procedure |
| 4. | Maximum time to wait for user input |
| 5. | Source of conversion rates for currencies |
| 6. | Ads to accompany over-rides due to urgency? (default is “No”, |
| | If “Yes” specify cutoff level - if any) |
| 7. | Use similarity measures for search? (default is “No”) |

After the storage of system setting data is complete, processing advances to a software block 203.

The software in block 203 prompts each customer (22) via a customer account window (402) to establish an account and/or to open an existing account in a manner that is well known. For existing customers (22), account information is obtained from a customer account table (561). New customers (22) have their new information stored in the customer account table (561). After the customer (22) has established access to the system, processing advances to a software block 205. Customers comprise the offering entities defined previously. The system can also obtain ad information from ad networks and entities that are not customers if it is made available on the Internet in xml or rdf format, via an API or some other means.

The software in block 205 prompts each customer (22) via an advertising window (403) to provide text, graphics and/or media that will be uploaded and stored for use in providing advertisements to the entity centric computer system (30). There are two different types of ads that can specified by a customer (22)—keyword ads and context ads. Table 4 shows the different types of keyword ads that can be specified for an offering. The system can also obtain ad information from ad networks and entities that are not customers.

TABLE 4

| Type of ad | Information Provided | Trigger(s) |
|---|---|---|
| Defined keyword | Specific text, graphics and/or | Use of a keyword in a context |
| | media that should be presented in | search and/or in an article |
| | a device specific format | |
| Customizable | Text, graphics and/or media that | Use of a keyword in a context |
| Keyword | should be presented in a format | search and/or in an article |
| | customized to the user and device | |
| Defined user- | Specific text, graphics and/or | Use of word that is linked in the |
| linked keyword | media that should be presented in | user's lexicon to a keyword used in |
| | a device specific format | a search and/or an article |
| Customizable | Text, graphics and/or media that | Use of word that is linked in the |
| user-linked | should be presented in a format | user's lexicon to a keyword used in |
| keyword | customized to the user and device | a search and/or an article |
| Defined predictive | Specific text, graphics and/or | Keyword related to an upcoming |
| keyword | media that should be presented in | decision being made by a user |
| | a device specific format | (20) |
| Customizable | Text, graphics and/or media that | Keyword related to an upcoming |
| predictive | should be presented in a format | decision being made by a user |
| keyword | customized to the user and device | (20) |

Table 5 shows the two types of context ads. In both types of ads (keyword and context) the customization consists of selecting the best combination of material for the specific user and/or changing words that the customer (22) has indicated can be changed to match the user's lexicon.

TABLE 5

| Type of ad | Information Provided | Trigger(s) |
|---|---|---|
| Defined context | Specific text, graphics | The current context of a user matches a |
| ad | and/or media that should be | customer defined context within a |
| | presented in a device | defined percentage. Context is defined |
| | specific format. | using one or more of the components of |
| | | context from a universal context |
| | | specification by layer (note: percentage |
| | | determined using one of the simrank or |
| | | simfusion algorithms). |
| Customizable | Text, graphics and/or media | The current context of a user matches a |
| context ad | that should be presented in | customer defined context within a |
| | a format customized to the | defined percentage. Context is defined |
| | user and device. Customer | using one or more of the components of |
| | identifies words and/or | context by layer from a universal context |
| | images that can be changed | specification (note: percentage |
| | as part of ad specification. | determined using one of the simrank or |
| | | simfusion algorithms). |

As part of the input process, the customer (22) is also asked to identify the price that will be paid for each ad and an interruption limit. The interruption limit gives the customer (22) the option of preventing an ad from accompanying a report or search that over-rides the system defined interruption limitations because of an identified urgency. The system operator (21) also has the ability to specify a limitation as part of the system settings process. The customer's input regarding keyword ads is stored in the application database (51) in a keyword ad material table (562) while the customer's input regarding context ads is stored in a context ad material table (563). After the advertising material has been stored, processing advances to a software block 207.

The software in block 207 prompts each customer (22) via an offer window (404) to define offers that will be provided to one or more users of an entity centric computer system (30) that is linked to the Personalized Commerce System (100). There are four different types of offers that can specified by a customer (22)—specific keyword, customized keyword, context specific and customized context offers. Table 6 shows more details about the different types of offers that can be specified for an offering. The system can also obtain offer information from networks and entities that are not customers if it is made available on the Internet in xml or rdf format, via an API or some other means.

TABLE 6

| Type of offer | Information Provided | Trigger(s) |
|---|---|---|
| Specific Keyword | Fixed offer - price (in base | Use of keyword in a search, use of |
| | currency), offering features | keyword in an article and/or a keyword |
| | and delivery options | related to an upcoming decision being |
| | | made by a user is identified by a |
| | | predictive search. |
| Customized | Price, offering features and | Use of keyword in a search, use of |
| Keyword | delivery options customized | keyword in an article and/or a keyword |
| | to meet user requirements | related to an upcoming decision being |
| | and goals of customer. | made by a user is identified by a |
| | Because this requires | predictive search. |
| | interaction between context | |
| | systems the process for | |
| | establishing interaction | |
| | between customer and user | |
| | systems is specified in next | |
| | step of processing. | |
| Context Specific | Fixed offer - price (in base | The current context of a user matches |
| | currency), offering features | a customer defined context within a |
| | and delivery options | defined percentage. Context is defined |
| | | using one or more of the components |
| | | of context from a universal context |
| | | specification by layer (note: percentage |
| | | determined using one of the simrank or |
| | | simfusion algorithms). |
| Customized | Price, offering features and | The current context of a user matches |
| Context | delivery options customized | a customer defined context within a |
| | to meet user requirements | defined percentage. Context is defined |
| | and goals of customer. | using one or more of the components |
| | Because this requires | of context from a universal context |
| | interaction between context | specification by layer (note: percentage |
| | systems the process for | determined using one of the simrank or |
| | establishing interaction | simfusion algorithms). |
| | between customer and user | |
| | systems is specified in next | |
| | step or processing. | |

As part of the input process, the customer (22) is also asked to identify the price that will be paid for each delivered offer and an interruption limit. Because the customized offers require interaction between a customer system (40, 60, 70 or 80) and an entity centric computer system (30) the customer (22) will be prompted to specify this procedure in the next stage of processing. The information defining the keyword offers is stored in a keyword offer table (564) while information defining the context offers is stored in a context offer table (565). After data storage is complete, processing advances to a software block 210.

The software in block 210 prompts each customer (22) via a procedure window (405) to define procedures that will be provided to one or more users (20) of an entity centric computer system (30) that is linked within the Personalized Commerce System (100). There are two different types of procedures that can specified by a customer (22)—offer procedures and information procedures. Table 7 shows more details the different types of procedures that can be specified by a customer (22).

TABLE 7

| Type of procedure | Information Provided | Trigger(s) |
|---|---|---|
| Offer | Method for interfacing with | Delivery of |
| | customer systems as | customized offer |
| | required to complete the | |
| | preparation of a customized | |
| | offer | |
| Information | Method for interfacing with | User response |
| | customer systems as | or request |
| | required to complete the | |
| | preparation of a customized | |
| | offer | |

As part of the input process, the customer (22) is also asked to identify the price that will be paid for each delivered procedure and an interruption limit. The information defining the procedures is stored in a procedure table (566). After data storage is complete, processing advances to a software block 211.

The software in block 211 provides the entity centric computer system (30) with advertisements, offers and/or procedures as appropriate for the context of each entity via a system interface window (406) that establishes and maintains a connection with each entity centric computer system (30) in a manner that is well known. As part of its processing, the software in block 211 may call on one or more Complete Context™ Services (625). Information about the delivery of advertisements for each customer is saved in an ad delivery table (567). Information about the delivery of offers for each customer is saved in an offer delivery table (568). Information about the delivery of procedures for each customer is saved in a procedure delivery table (569). The information from these three tables are used to prepare a bill for each customer. The monthly totals are saved in the customer account table (561). If the user (20) has allowed the Personalized Commerce System (100) to track changes in context, then contexts that were associated with a purchase transaction will be captured and stored in a purchase context table (570) for dissemination to customers (22). This information will enable customers (22) to better identify contexts that are appropriate for Complete Context™ advertisements and will also allow the operators of the Personalized Commerce System to receive payments for sales in addition to (or in place of payments per ad, offer and/or procedure.

While the above description contains many specificities, these should not be construed as limitations on the scope of the invention, but rather as an exemplification of one embodiment thereof. Accordingly, the scope of the invention should be determined not by the embodiment illustrated, but by the appended claims and their legal equivalents.

What is claimed is:

1. A program storage device readable by a machine, tangibly embodying a non transitory program of instructions executable by the machine to perform steps, the steps comprising:
aggregating a plurality of data related to a user entity and to one or more offerings that may be provided by one or more offering entities to said user entity in a format suitable for automated analysis;
transforming at least a portion of said data into a context for said user entity;
using said context and the data for the one or more offerings to create a personalized offering for one or more steps in a commerce chain
where the one or more steps in a commerce chain are selected from the group consisting of advertise, configure, produce, offer and deliver.

2. The program storage device of claim 1, wherein the personalized offering comprises an optimal offering for the user entity, the offering entity or for a combination thereof.

3. The program storage device of claim 1, wherein the personalized offering is selected from the group consisting of ad, configuration, data, information, knowledge, media, product, service, offer term, offer condition, delivery mode, delivery time and delivery location.

4. The program storage device of claim 1, wherein the personalized offering is delivered as a time when the user entity is most likely to be receptive to an interruption.

5. The program storage device of claim 1, wherein the personalized offering is delivered as required to support an upcoming decision.

6. The program storage device of claim 1, wherein the personalized offering is delivered when the user context matches a pre-defined context or when a keyword is entered into a search.

7. The program storage device of claim 1, wherein the user context comprises a complete context.

8. A personalized offering method, comprising:
using a computer to complete the steps of:
aggregate a plurality of data related to a user entity and to one or more offerings that may be provided by one or more offering entities to said user entity in a format suitable for automated analysis;
transform at least a portion of said data into a context for said user entity;
use said context and the data for the one or more offerings to create a personalized offering for one or more steps in a commerce chain
where the one or more steps in a commerce chain are selected from the group consisting of advertise, configure, produce, offer and deliver.

9. The method of claim 8, wherein the personalized offering comprises an optimal offering for the user entity, the offering entity or for a combination thereof.

10. The method of claim 8, wherein the personalized offering is selected from the group consisting of ad, configuration, data, information, knowledge, media, product, service, offer term, offer condition, delivery mode, delivery time and delivery location.

11. The method of claim 8, wherein the personalized offering is delivered as a time when the user entity is most likely to be receptive to an interruption or when a keyword is entered into a search.

12. The method of claim 8, wherein the personalized offering is delivered as required to support an upcoming decision.

13. The method of claim 8, wherein the personalized offering is delivered when the user context matches a pre-defined context.

14. The method of claim 8, wherein the user context comprises a complete entity context.

15. A system for personalized commerce comprising: a computer with a processor having circuitry to execute instructions; a storage device available to said processor with sequences of instructions stored therein, which when executed cause the processor to:
aggregate a plurality of data related to a user entity and to one or more offerings that may be provided by one or more offering entities to said user entity in a format suitable for automated analysis;
transform at least a portion of said data into a context for said user entity;
use said context and the data for the one or more offerings to create a personalized offering for one or more steps in a commerce chain
where the one or more steps in a commerce chain are selected from the group consisting of advertise, configure, produce, offer and deliver.

16. The system of claim 15, wherein the personalized offering comprises an optimal offering for the user entity, the offering entity or for a combination thereof.

17. The system of claim 15, wherein the personalized offering is selected from the group consisting of ad, configuration, data, information, knowledge, media, product, service, offer term, offer condition, delivery mode, delivery time and delivery location.

18. The system of claim 15, wherein the personalized offering is delivered as a time when the user entity is most likely to be receptive to an interruption.

19. The system of claim 15, wherein the personalized offering is delivered as required to support an upcoming decision or when a keyword is entered into a search.

20. The system of claim 15, wherein the personalized offering is delivered when the user context matches a pre-defined context.
